(19) United States
(12) Patent Application Publication
(10) Pub. No.: US 2005/0049904 A1
(43) Pub. Date: Mar. 3, 2005

(54) Process for business quality control

(76) Inventor: Almut D. Von Biedermann, Ellicott City, MD (US)

Correspondence Address: Ms. Almut von Biedermann, 4672 Morgan Court, Ellicott City, MD, 21043, US

(21) Appl. No.: 10/925,446

(22) Filed: Aug. 25, 2004

Related U.S. Application Data
(60) Provisional application No. 60/497,137, filed on Aug. 25, 2003.

(51) Int. Cl. G06F 17/60

(52) U.S. Cl. 705/7

(57) ABSTRACT

The present invention is directed to providing a new quality control business process for businesses. The process is based upon organizational learning and authentic leadership using a cognitive approach. The invention identifies a natural life cycle of a business, the investment funding stages of the business and at least eleven operational functions that the business must perform. The invention utilizes a unique stage-gate mechanism corresponding to each of the eleven operational functions. The stage-gates require each business to meet the requirements of each of the stage-gates before allowing it to move towards completion. The cycle, stages and functions occur in concert to provide the business with a financially sound, operationally sound, sustainable, fundable and successful outcome.

This application claims priority from provisional application 60/497,137 filed Aug. 25, 2003.

### COPYRIGHT NOTICE

Material disclosed in this US patent application is subject to copyright protection. The copyright owner has no objection to the facsimile reproduction by any one of the patent document or the patent disclosure, as it appears in the Patent and Trademark Office patent files or records, but otherwise reserves all copyright rights whatsoever.

### BACKGROUND OF THE INVENTION

The Small Business Administration (SBA) estimates that 80% of all businesses in the United States are small to medium sized. While job growth is fueled by businesses of these magnitudes, the SBA also reports that less than 50% of all businesses continue to remain viable after five years. The SBA estimates that many of these businesses may have continued to remain in existence were they to have availed sound business practices in all segments of the business process and have had access to appropriate funding. The relationship between business practice and appropriate funding is intimately linked and business success is not directly proportional to the ability to secure funding. For example, businesses that succeed accidentally may not be able to sustain themselves due to a lack of planning and thus are considered high risk by funding sources.

As discussed below, processes for evaluating business plans, business management and growth have been disclosed in the prior art. While these processes overcome some of the problems associated with developing methods to address business management, none of the processes provide comprehensive and concise manner of providing business assistance to emerging and existing small to mid-size corporations as the present invention.

For example, United States Patent Application Publication U.S. 2003/0093310 A1 to Macrae discloses and claims a Business Management Process (BMP) that includes seven standardized phases of management that assist existing companies in deriving and attaining company goals. These include an Executive Planning Phase 100, a Market Analysis Phase 110, an Organizational Planning Phase 120, a Resource Allocation Phase 130, an Implementation Phase 140, an Evaluation Phase 150, and a Modification Phase 160. Each of the phases includes a plurality of deliverables. While Macrae discloses a detailed business-planning program, he is distinguished from the present invention in several ways. In order to utilize Macrae's BMP, one must first assume that all businesses have identical infrastructures. Macrae fails to account for variables such as experience, strengths and weaknesses of an individual business or the length of time each business has been in existence. Secondly, in order to implement the BMP, Macrae assumes that each business initiates it at the Executive Planning Phase and ends with the Evaluation or Modification Phase. Thus, Macrae requires each business utilizing the BMP to (a) have an infrastructure that allows for a linear business planning program; (b) have an infrastructure to support each and every phase of the program; (c) require each business to have the business acumen to understand each phase of the program; and (d) accurately implement and obtain successful results from each phase. Note that Macrae does indicate that all seven phases are not always necessary, but does not disclose a manner of implementation (see column 2, paragraph 23). Thirdly, Macrae does not account for businesses to acquire learning curves from the BMP, factor in time or the ability to enhance strengths and limit the pitfalls of individual businesses from the BMP. Rather Macrae's BMP provides a quantitative deliverables based upon quantitative and qualitative factors.

United States Patent Application Publication U.S. 2004/0142470 A1 to Myrick, et al., discloses and claims a complex business management system that interconnects strategic business planning with strategic information technology planning. The strategic IT planning requires each corporation to be identified by manageable components, to provide an overall system to describe each manageable component, and to provide a common means of communicating between the various components. As shown in FIG. 4, client-specific architectures require mandatory components that must be met in order to drive the invention towards deliverable. While Myrick, et al., does disclose an interconnected multi-level business management process, it is distinguished from the present invention in several ways. Firstly, the Myrick, et al., system is a complex system directed to large corporations having divisions, multiple sites and a large-scale corporate structure. The mandatory phases are sequentially required and do not provide for business having basic start-up issues as per Macrae discussed above. Additionally, Myrick, et al., fails to disclose stop and go mechanisms that enable businesses to “work out” glitches while still progressing through the business program.

United States Patent Application Publication 2003/0074212 to Lun discloses and claims a real-time, online financial evaluation of small to medium sized businesses. The invention utilizes financial information generated from a database of similar businesses to determine long and short-term data analysis, diagnostics, financial health, and the ability to obtain funding. This program utilizes a questionnaire format that requires the user to “enter financial data of the enterprise for the past few years.” See column 3, paragraph 39. While Lun provides a financial analysis, it is distinguished from the present invention in several ways. Firstly, Lun discloses a single factor analysis for the purposes of determining financial stability. Secondly, Lun's program is exclusive to a comparative analysis based upon similar businesses. Thirdly, Lun requires data for the “past few years” in order to be able to provide financial analysis. See column 3, paragraph 39. Lun cannot ascertain the feasibility of a start-up business nor provide a multi-dimensional quantitative and qualitative analysis as the present invention.

United States Patent Application Publication U.S. 2002/0169658 A1 to Adler discloses and claims a modeling and analysis tool to help companies ascertain strategies and risks based upon simulated “outcomes of candidate decisions over time.” See column 4, paragraph 32. The invention provides a variety of outcomes to allow the user to assess risk and determine the best course of action for the business. While Adler does provide a quantitative and qualitative approach to business planning, it is a simulative approach based upon the inputs provided by the user. This method allows for a plurality of alternative approaches and risk managements schemes for businesses. However, unlike the present invention, it is not evaluative in real time and does not provide a mechanism for risk assessment or quality control that is multidimensional.

U.S. Pat. No. 6,371,848B1 to Ashby discloses and claims a board/software game that simulates a business from start-up to public offering. The game identifies four stages from start-up to public offering and requires each player to outline a business plan as shown in FIG. 2. Ashby provides that each player must attain “certain milestones in each stage or at the culminating Finance Round.” See column 2-3, lines 65+. While Ashby provides a milestone system that precludes a player from advancing to the next stage, it is distinguished from the present invention in several ways. Firstly, Ashby's overall system is linear (progression from a first stage to a second, etc). Secondly, the system is based upon the random roll of the dice and the random selection of stage cards. Finally, each player is given the exact same starting point and the exact same venture seed capital at the beginning of the game. The system is logical given that Ashby discloses and claims a game, but is not sound for the purposes of providing management assistance for real-life businesses.

U.S. Pat. No. 6,073,109 to Flores, et al., discloses and claims a workflow business process that is utilized to manage a range of operations such as filling out forms to complex multi-task operations. While this system is multidimensional, it is related to the operations of existing businesses and ways to economize it to the business's best interests. This reference is significantly different from the present invention, as it does not disclose ways in which to determine the quality control or risk management of a wide variety of businesses.

In addition to the references cited above, the following references provide a scope of the references in this field:

United States Patent Application Publication U.S. 2004/073442 A1 to Heyns, et al., discloses and claims a budgeting process for existing corporations.

United States Patent Application U.S. 2001/0053991A1 to Bonabeau discloses and claims generating a plurality of new business models to address business problems and then optimizing the models for finding improved and effective solutions to the business.

United States Patent Application Publication U.S. 2004/0111351 A1 to Ikeda, et al., discloses and claims a business management quality control system for shareholders and stakeholders that utilizes financial and non-financial data for a business to obtain a quality index.

Patent Cooperation Treaty Application WO 97/48063 to Schimitzek discloses a business management computer system that utilizes a variety of factors such as manufacturing in determining a goods manufacturing process in real-time.

The present invention described and claimed below address the problems faced by business and provide a new and novel manner to address business quality control.

### SUMMARY

It is, therefore, an objective of the present invention to provide a process for start-up, small and medium sized business to manage growth and position for investment purposes, build the necessary business infrastructure, allocate resources according to need.

It is an objective of the present invention to provide a foundation process for developing a financially sound, operationally sound, sustainable, fundable and successful businesses.

It is an objective of the present invention to plan, execute, price, promote and distribute ideas, goods and services.

It is also an objective of the present invention to provide a best practices business process that is capable of satisfying individual and organizational objectives.

It is yet another objective of the present invention to provide a dynamic, standardized, individual management process that helps to control risk.

It is also an objective of the present invention to provide a preferred embodiment directed to Sustainable Business Excellence (SBE) process that provides a business management and progress system for business incubator companies. These and other objectives are discussed below.

### BRIEF DESCRIPTION OF THE DRAWINGS

FIG. 1 shows the interconnection between the Natural Business Life Cycle, the Business Investment Funding Pyramid and the Operational Functions Cycle.

FIG. 1a shows the phases of the Natural Business Life Cycle.

FIG. 1b shows the phases of the Business Investment Funding Phase.

FIG. 1c shows the Operational Functions Cycle and its operational functions.

FIG. 1d shows the relationship between the Natural Business Life Cycle and the Operational Functions Cycle.

FIG. 1e shows the relationship between the Business Investment Funding Pyramid and the Operational Functions Cycle.

FIG. 1f shows an example of the present invention for a technology-based company.

FIG. 2 shows the Natural Business Life Cycle, the Business Investment Funding Pyramid and the SBE Operational Functions of the SBE process.

FIG. 2a shows the Product Management Excellence portion and the Business Management Excellence Portion of the SBE Operational Functions.

FIG. 2b shows stage-gates corresponding to the Product Management Functions portion and the Business Management Functions portion of the SBE process.

FIG. 2c shows the Product Management Functions, the Business Management Functions and its corresponding stage-gates.

### DETAILED DESCRIPTION OF THE EMBODIMENTS

The present invention incorporates a plurality of steps that may be performed by hardware components or may be embodied in machine-executable instructions, that in turn may be used to cause a processor to logic circuits programmed with the relevant instructions to execute the plurality of steps. Alternatively, the steps may be performed by a combination of hardware and software, as is understood by one of ordinary skill in the art.

The present invention may be provided as a computer program product that may include a machine readable medium having the necessary storage capacity to have stored therein instructions used to program devices such as computers or the like to perform a process according to the present invention. This machine readable medium includes but is not limited to Zip-drives, optical disks, floppy disks, CD-ROMs, ROM, RAM, EPROM, EEPROMS, flash memory, and other mediums as is understood by one of ordinary skill in the art.

Additionally, the present invention may also be downloaded as a computer program product, wherein the program may be transferable between computers via communication links and computer readable signals, as is understood by one of ordinary skill in the art.

While the present embodiments are directed to start-up, small and medium sized start up businesses, it is understood that the present invention encompasses all sizes business endeavors and other non-business related mechanisms.

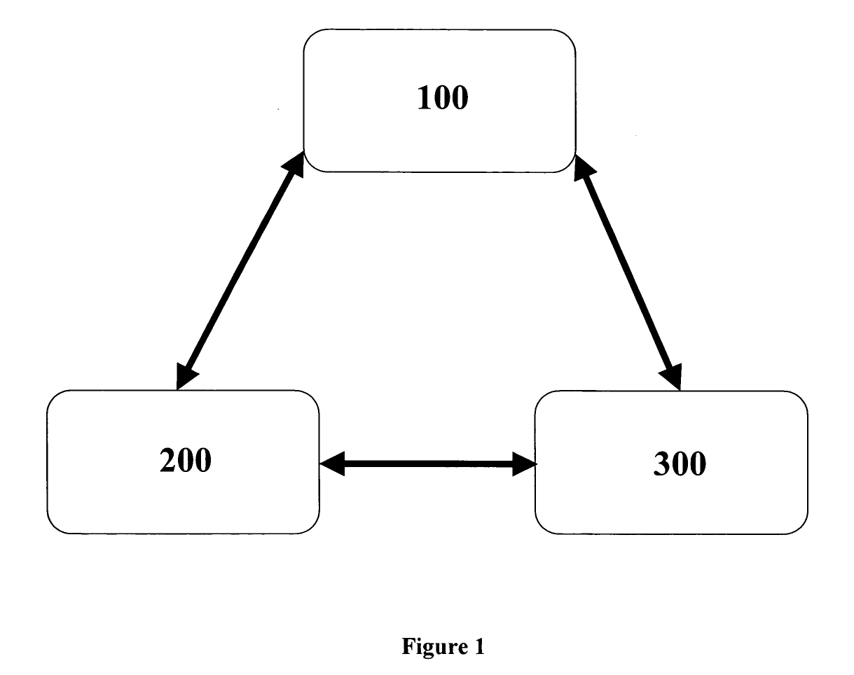

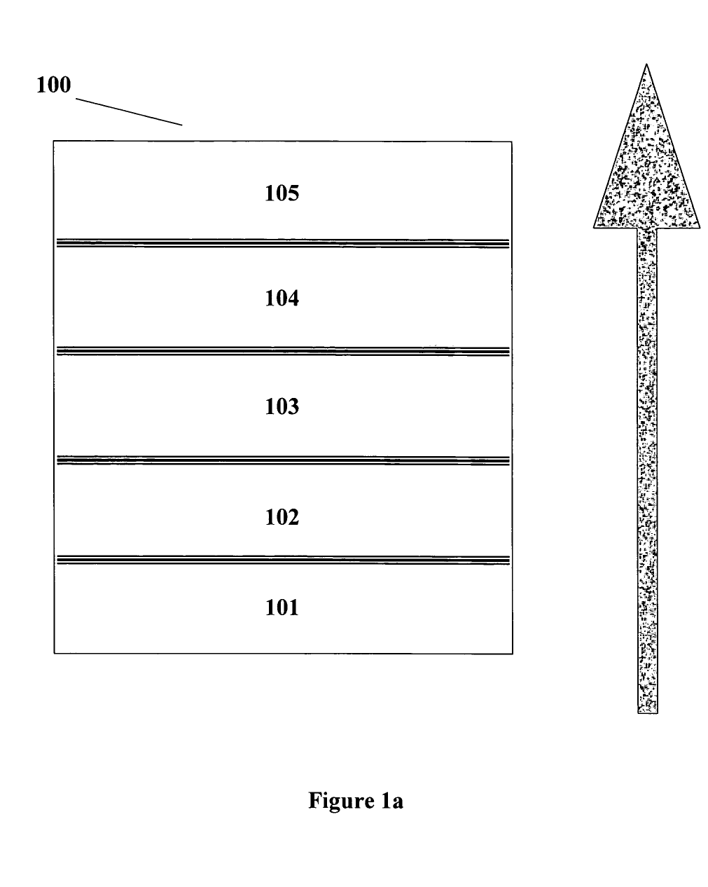

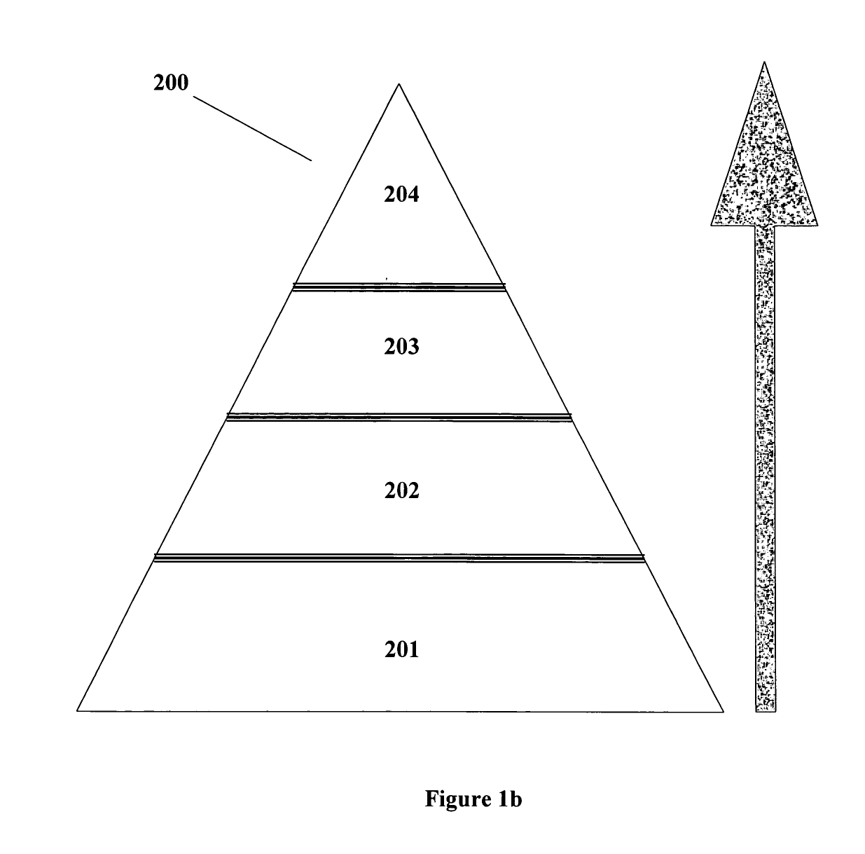

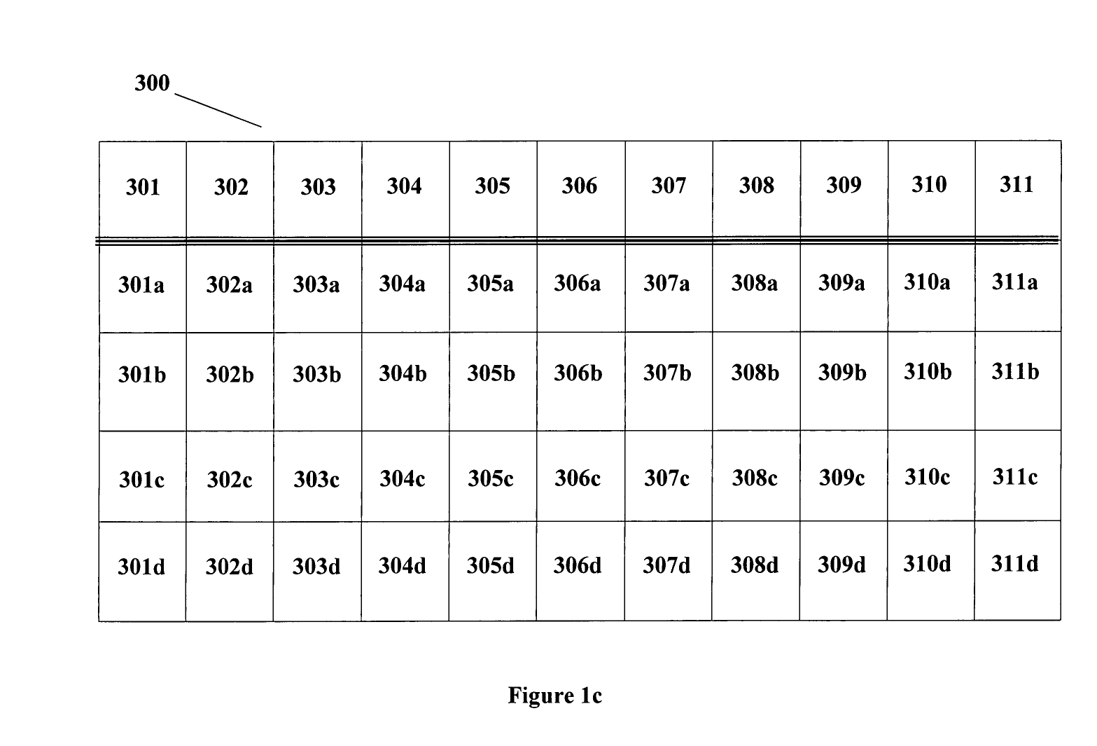

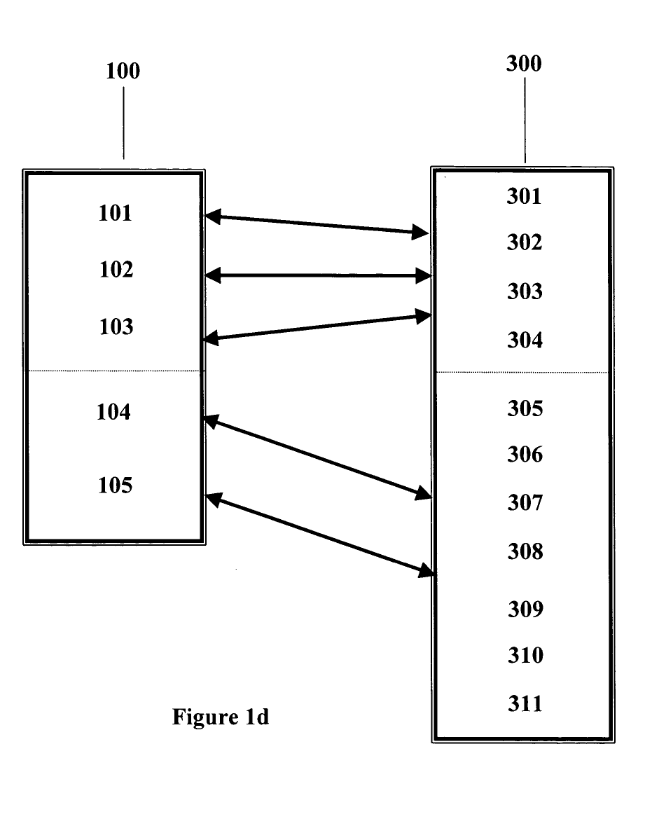

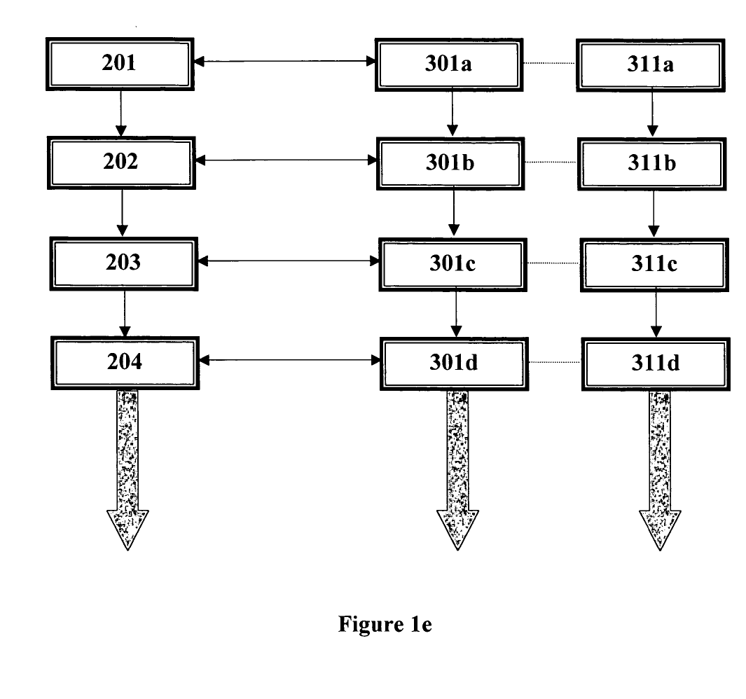

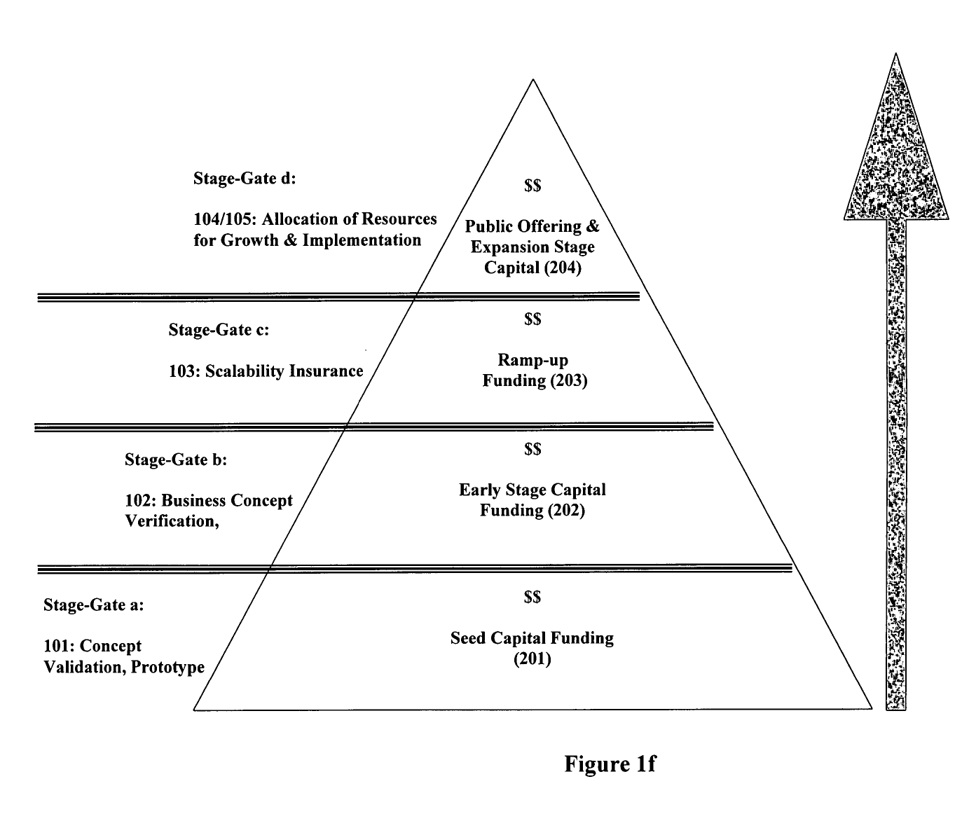

As shown in FIG. 1, the present invention provides a multi-dimensional, organizational learning and authentic leadership based cognitive solution to managing companies by combining a Natural Business Life Cycle 100 with a Business Investment Funding Phase 200 and a Operational Functions Cycle 300. As shown in FIG. 1, the Natural Business Life Cycle 100 is interlinked with the Business Investment Funding Phase 200 and the Operational Functions Cycle 300 to provide a dynamic quality control business process that is comprehensive without being complex.

The Natural Business Life Cycle

As shown in FIG. 1a, the Natural Business Life Cycle 100 is a linear step-driven process that begins with a means for validating the business concept or validate concept phase 101. Upon validation, the business must provide a means for developing an economic model or a verify business economic model phase 102. Subsequent to the verification phase 102, the business must then provide a means to allow the business to scale up its model or an ensure scalability phase 103. Subsequent to the scalability phase 103, the business must provide a means for deciding where to place resourses to initiate growth as well as to balance out business weaknesses. This is also known as the allocate resources phase 104. Finally, upon completion of the resources phase 104, the business is ready to provide a means for implementing its business goals and transition into a fully operational venture. This is also known as the implement phase 105. As will be discussed below, phases 101 through 103 focus on product development while phases 104 through 105 focus on business operations and development.

The Business Investment Funding Pyramid

As shown in FIG. 1b, the Business Investment Funding Pyramid 200 is investment and funds driven. The pyramid 200 is a unique embodiment of the present invention. The Business Investment and Funding Pyramid 200 is a liner process that begins with a base means for generating a business idea and compiling a business plan including the initial development of a business prototype. This is also known as the concept phase 201. Subsequent to the concept phase 201, the business progresses to a means for testing one or more of its business prototypes in the first of its field applications. This is also known as the alpha test and launch 202. Subsequent to the alpha test and launch 202, the business progresses to a means for providing several field applications and a means for building, verifying and modifying the business model around several field models. This is known as the beta test and ramp-up 203. Examples include price setting for the models and obtaining a feel for the real market prices. Upon completion of the beta test and ramp-up, the business is ready to implement a means for providing a selling process of the product. This is also known as the gamma test and roll-out 204.

The Operational Functions Cycle

As shown in FIG. 1c, the Operational Functions Cycle 300 is a multidimensional cycle that incorporates eleven operational functions 301 through 311. Each of the operational functions 301 through 311 includes four stage-gates, or a through d, such that operational function 301 includes stage-gates 301a, 301b, 301c and 301d; operational function 302 includes stage-gates 302a through 302d, operational function 303 includes stage-gates 303a, 303b, 303c, 303d; operational function 304 includes stage-gates 304a, 304b, 304c, 304d; operational function 305 includes stage-gates 305a, 305b, 305c, 305d; operational function 306 includes stage gates 306a, 306b, 306c, 306d; operational function 307 includes stage-gates 307a, 307b, 307c, 307d; operational function 308 includes stage-gates 308a, 308b, 308c, 308d; operational function 309 includes stage-gates 309a, 309b, 309c, 309d; operational function 310 includes stage-gates 310a, 310b, 310c, 310d; and operational function 311 includes stage-gates 311a, 311b, 311c, 311d.

In this manner, the present invention provides a unique eleven by four matrix with each stage-gate delineating a minimum “pass” standard before allowing the business to move beyond the respective stage-gate. In use, each business is required to begin at one of the stage-gates for each of the eleven Operational Functions Cycle 300 and complete the requirements within each stage-gate until all of the requirements for each of the eleven Operational Functions Cycle 300 have been met.

It is important to note that the present invention is based upon the premise that all businesses are not created equal, that each business has unique needs and that each business presents differences in business skills, business experience, financial development and technical expertise. Thus, the present invention allows each business the capability of a different starting stage-gate within the operation functions 300.

It is also important to note that the present invention is capable of increasing or decreasing the matrix to fit the requirements of a specific concern or industry.

As discussed above, the present invention requires that the Natural Business Life Cycle 100, the Business Investment Funding Pyramid 200 and the Operational Functions Cycle 300 be interlinked. This linkage creates the multi-dimensional facet of the present invention. The relationship between the Natural Business Life Cycle 100 and the Operational Functions Cycle 300 is shown in FIG. 1d. Phases 101, 102 and 103 occur in concert with Functions 301, 302, 303 and 304. While Phases 104 and 105 occur in concert with Functions 305, 306, 307, 308, 309, 310 and 311.

The relationship between the Business Investment Funding Pyramid 200 and the Operational Functions Cycle 300 is shown in FIG. 1e. The concept phase 201 of the Business Investment Phase 200 corresponds with stage-gate a of one or more of the operational function 301-311 relevant to funding. The alpha test and launch 202 corresponds with stage-gate b of one or more of the operational function 301-311 relevant to funding. The beta test and ramp-up 203 corresponds with stage-gate c of one or more of the operational function 301-311 relevant to funding. The gamma test and roll-out 204 corresponds to stage-gate d of one or more of the operational function 301-311 relevant to funding.

FIG. 1f is an example of the present invention for a technology based company. Here, concept phase 201 of the Business Investment Funding Pyramid 200 begins with obtaining Seed Capital Funding. The business then progresses to the alpha test and launch 202 by obtaining early-stage capital funding. Subsequently, the business progresses to the beta test and ramp-up 203 by obtaining ramp up stage funding. Finally, the business is ready to enter the gamma-test and roll-out 204 by public offerings and obtaining expansion stage capital. To fully demonstrate the multi-dimensional aspect of the present invention, FIG. 1f also shows the Natural Business Life Cycle phases 101-105 and the stage-gates a through d for a funding operational functions of the Operational Functions Cycle 300 corresponding with the respective Business Investment and Funding Pyramid 200 phases.

In a preferred embodiment, the present invention is directed to a Sustainable Business Excellence (SBE) process that provides a business management and progress system for business incubator companies. Incubator programs are unique funded programs that provide a variety of assistance for start-up, small and medium sized businesses. By tracking an incubator company's progress, based on specific benchmarks, the SBE provides management, staff, clients and investors with an objective perspective regarding the incubator company's development.

The SBE process of the present invention utilizes the principles of absorptive capacity and the learning curve to improve a business to better allocate its resources. By definition, absorptive capacity is the ability of a business, concern, society or culture to implement new technology. The absorptive capacity of a business is based upon many factors. For example, societies with low literacy rates tend to be relatively slower to adopt cutting edge technologies then societies having educated workers. In another example, business culture may foster resistance to automation or implementation of new technologies. These conditions will impact the ability of a business to absorb new implementations. The learning curve, by definition is the ability of a business to become proficient with a concept or technology. In general, the learning curve is approximated by the decline in average costs across time or the increase in productivity over time as cumulative output increases (obtained from http://www.unc.edu, and incorporated herein by reference). The SBE process of the present invention accounts for these principles in development of its process structure described below.

The primary function of the SBE process is to move an incubator company from start-up through early-stage development to a later-stage development. A company capable of meeting all of the SBE requirements is capable of leaving the confines of the incubator to self-management.

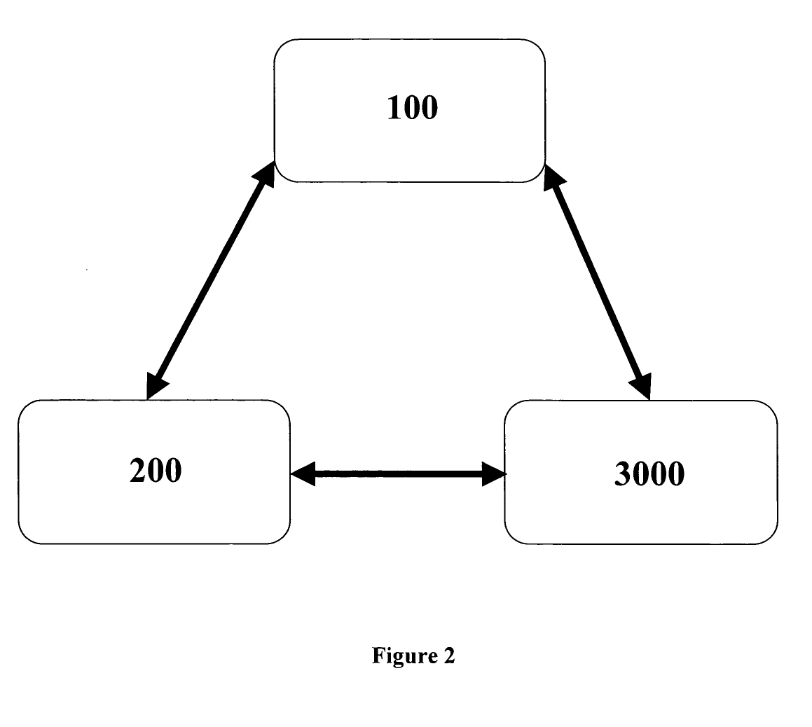

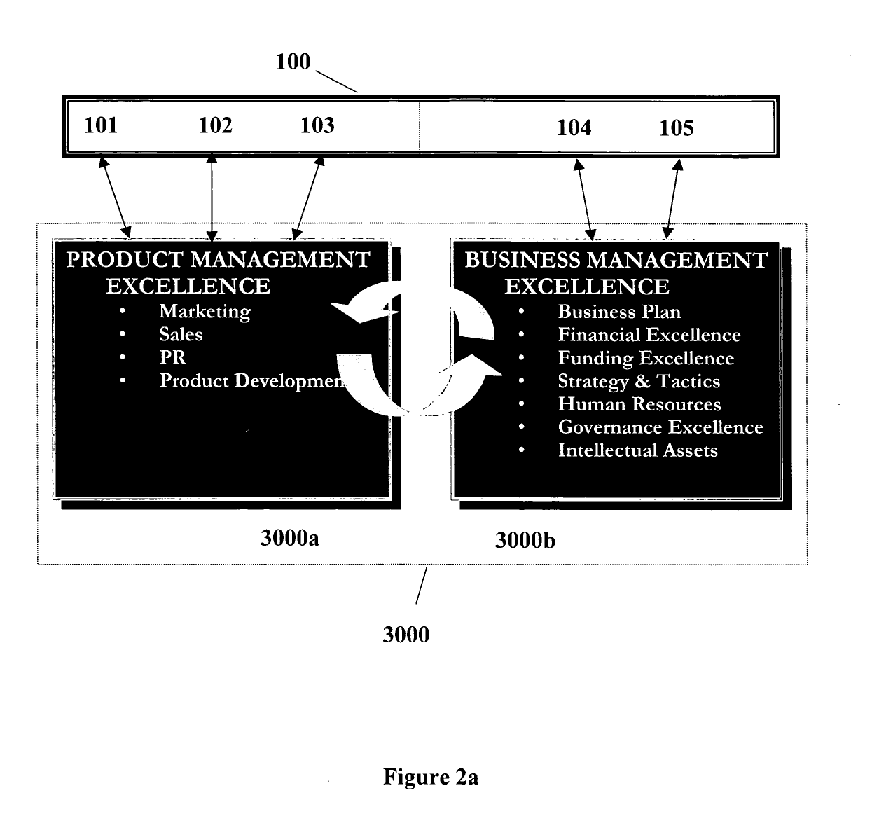

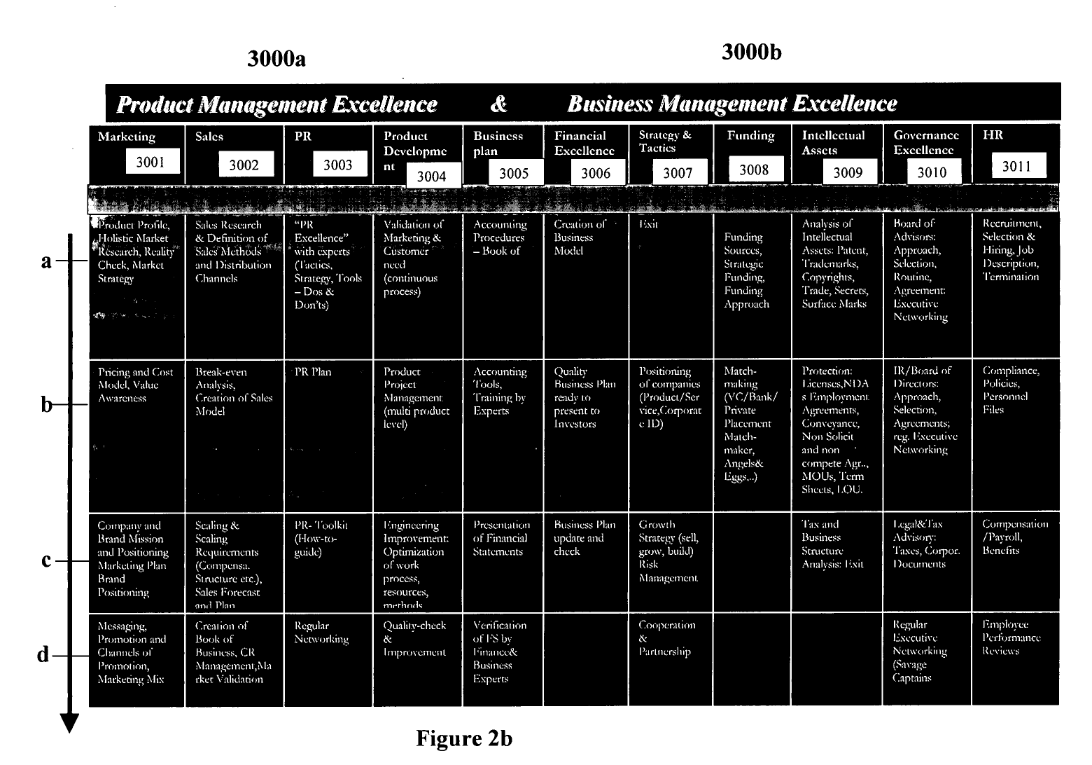

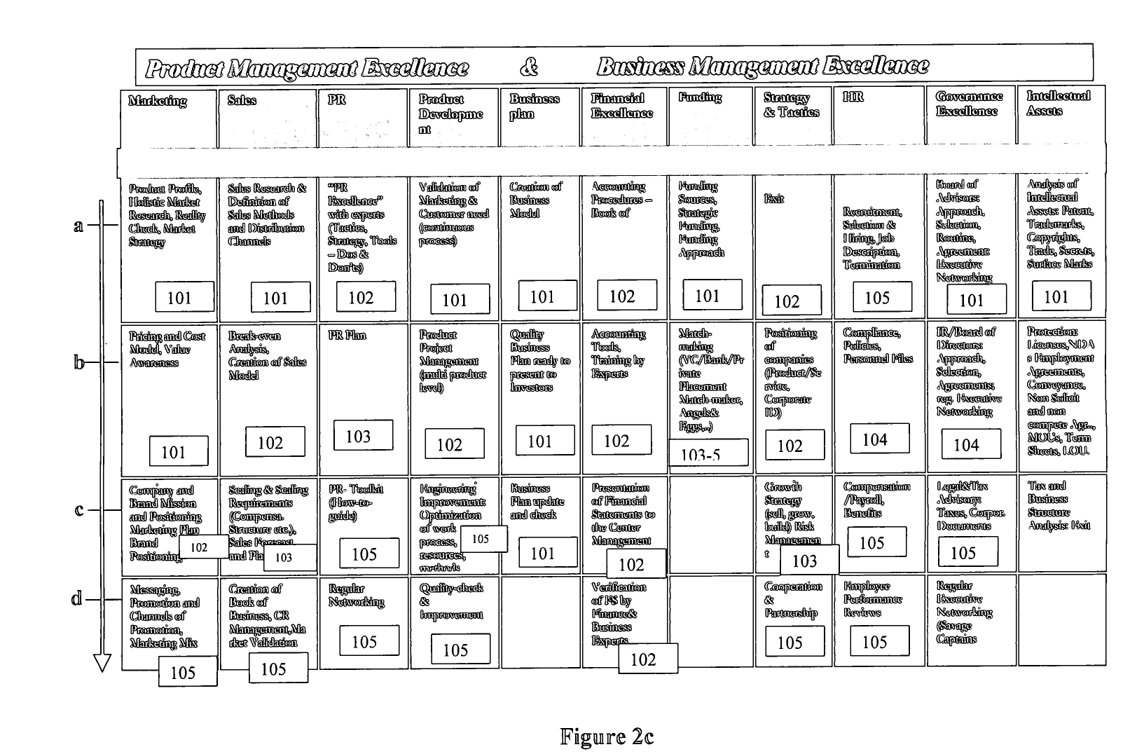

As shown in FIG. 2, the SBE process of the present invention is based upon the Natural Business Life Cycle 100, Business Investment Funding Pyramid 200 and a SBE Operational Functions 3000.

In a preferred embodiment, as shown in FIG. 2a, the Operational Functions 3000 includes a Product Management Excellence portion 3000a and a Business Management Excellence Portion 3000b. The Product Management Excellence portion 3000a includes marketing, sales, public relations and product development. The Business Management Excellence Portion 3000b includes business plans, financial excellence, funding excellence, strategy & tactics, human resources, governance excellence and intellectual assets. Similar to the relationship between the Natural Business Life Cycle 100 and the Operational Functions Cycle 300, as shown in FIG. 1d, phases 101, 102 and 103 of the Natural Business Life Cycle 100 occurs in concert with marketing, sales, public relations and product development of the Product Management Excellence portion 3000a. While Phases 104 and 105 occur in concert with business plans, financial excellence, funding excellence, strategy & tactics, human resources, governance excellence and intellectual assets of the Business Management Excellence Portion 3000b.

As will be understood by one skilled in the art, the Business Investment Funding Pyramid 200 as shown in the figures above, corresponds with the relevant stage-gates a through d of the Product Management Excellence Portion 3000a and the Business Management Excellence Portion 3000b as shown in the figures above.

Similar to the multidimensional Operational Functional Cycle 300 discussed above, SBE Operational Function 3000 is also multidimensional and includes eleven operational functions and four stage-gates. As is understood to one skilled in the art, the scope of the present invention provides that the Operational Function 3000 can be customized to include fewer or greater operational functions as necessary.

In another preferred embodiment, FIG. 2b shows stage-gates a through d corresponding to Product Management Functions portion 3000a and Business Management Functions portion 3000b of a SBE process for a pure products company as it transitions from start-up to bona-fide operation. Operations functions 3001-3011 are denoted by specific subject matter functions, while each of the operations function stage-gates a through d are also denoted by specific tasks.

FIG. 2c shows the Product Management Functions 3000a and Business Management Functions 3000b its corresponding stage-gates a through d and corresponding phases 101 through 105 as it corresponds to an exemplary SBE process for a pure product company as it transitions from a start up to a bona-fide business operation.

Through the descriptive figures and discussion, the present invention provides a multitude of business process scenarios to enable businesses to formulate realistic business goals.

Alternate Embodiments

The specification, above, describes the present invention with reference to specific embodiments. One of skill in the art will recognize that various modifications and changes can be made without departing from the broad spirit and scope of the present invention. The specification and drawings are, therefore, regarded as illustrative of the broad scope of the invention, are not intended to be limiting.

1. A multidimensional method for managing quality control of a business comprising:
developing a Natural Business Life Cycle for said business;
developing a Business Investment Funding Pyramid for said business;
developing an Operational Functions Cycle for said business;
conforming said Natural Business Life Cycle, said Business Investment Funding Pyramid and said Operational Functions Cycle to occur in concert with one another; and
providing said business with a means for managing growth develop infrastructure and allocate resources, based upon said Natural Business Life Cycle, said Business Investment Funding Pyramid and said Operational Functions Cycle.

2. A method according to claim 1, wherein said Natural Business Life Cycle comprises identifying a concept phase, a business economic model verification phase, an ensure scalability phase, an allocate resources phase and an implementation phase.

3. A method according to claim 2, wherein said Business Investment Funding Pyramid comprises identifying a concept phase, an alpha test and launch phase, a beta test and ramp-up, and a gamma test and roll-out.

4. A method according to claim 3, wherein said Operational Functions Cycle comprises
identifying a plurality of operational functions;
identifying a plurality of sequential-stage gates for each of said operation functions;
forming an matrix of said operational functions and said stage-gates;
conforming each of said stage-gates with tasks relating to said operation functions; and
requiring said business to pass said stage-gates in a sequential manner.

5. A method according to claim 4, wherein said plurality of operational functions comprises eleven different functions and said each plurality of stage-gates comprises a first, second, third and fourth gate.

6. A method according to claim 5, wherein said method further comprises allowing said business to enter said Operational Functions Cycle at any one of said first, second, third or fourth sequential stage gates.

7. A multidimensional method for developing a Sustainable Business Excellence (SBE) business comprising:
developing a Natural Business Life Cycle for said business;
developing a Business Investment Funding Pyramid for said business;
developing an SBE Operational Functions Cycle for said business;
conforming said Natural Business Life Cycle, said Business Investment Funding Pyramid and said SBE Operational Functions Cycle to occur in concert with one another; and
providing said business with an absorptive capacity for managing growth develop infrastructure and allocate resources, based upon said Natural Business Life Cycle, said Business Investment Funding Pyramid and said SBE Operational Functions Cycle.

8. A method according to claim 7, wherein said Natural Business Life Cycle comprises identifying a concept phase, a business economic model verification phase, an ensure scalability phase, an allocate resources phase and an implementation phase.

9. A method according to claim 8, wherein said Business Investment Funding Pyramid comprises identifying a concept phase, an alpha test and launch phase, a beta test and ramp-up, and a gamma test and roll-out.

10. A method according to claim 9, wherein said SBE Operational Functions Cycle comprises:
identifying a plurality of operational functions;
identifying a plurality of sequential-stage gates for each of said plurality of operation functions;
forming a matrix of said operational functions and said stage-gates;
conforming each of said stage-gates with tasks relating to said operation functions; and
requiring said business to pass said stage-gates in a sequential manner.

11. A method according to claim 10, wherein said plurality of operational functions comprises eleven different functions and said each plurality of stage-gates comprises a first, second, third and fourth gate.

12. A method according to claim 11, wherein said method further comprises allowing said business to enter said SBE Operational Functions Cycle at any one of said first, second, third or fourth sequential stage gates.

13. A computer-driven multidimensional process for developing a business system comprising:
developing a Natural Business Life Cycle for said business;
developing a Business Investment Funding Pyramid for said business;
developing an Operational Functions Cycle for said business;
conforming said Natural Business Life Cycle, said Business Investment Funding Pyramid and said Operational Functions Cycle to occur in concert with one another; and
providing said business with a means for managing growth develop infrastructure and allocate resources, based upon said Natural Business Life Cycle, said Business Investment Funding Pyramid and said Operational Functions Cycle.

14. A process according to claim 13 and further comprising said Operational Functions Cycle having a plurality of operations functions wherein each of said operations functions having a plurality of stage-gates and utilizing said computer to generate a plurality of matrices of said operations functions and said stage-gates.
